(19) United States
(12) Patent Application Publication
(10) Pub. No.: US 2004/0257943 A1
(43) Pub. Date: Dec. 23, 2004

(54) Data reproducing device and control method of data reproducing device

(75) Inventors: Masayuki Kll, Kanagawa (JP); Jun Wakasugi, Kanagawa (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: Kabushiki Kaisha Toshiba, Tokyo (JP)

(21) Appl. No.: 10/819,943

(22) Filed: Apr. 8, 2004

(30) Foreign Application Priority Data
May 20, 2003 (JP) 2003-141635

(51) Int. Cl. G11B 5/58

(52) U.S. Cl. 369/53.2; 369/53.31

(57) ABSTRACT

A data reproducing device disclosed herein comprises: a disk analysis executor which performs a disk analysis of analyzing a file and directory structure of a record medium; a detection judgment section which judges whether or not a predetermined number of files and/or a predetermined number of directories including a file is detected by the disk analysis executor; and a reproduction starter which suspends the disk analysis and starts reproduction of data of the detected file when the detection judgment section judges that the predetermined number of files and/or the predetermined number of directories including the file is detected.

### CROSS REFERENCE TO RELATED APPLICATION

This application claims benefit of priority under 35 U.S.C.§119 to Japanese Patent Application No. 2003-141635, filed on May 20, 2003, the entire contents of which are incorporated by reference herein.

### BACKGROUND OF THE INVENTION

1. Field of the Invention

The present invention relates to a data reproducing device and a control method of the data reproducing device, and particularly relates to a data reproducing device which realizes a reduction in the time required before file reproduction is started and a control method of the data reproducing device which realizes the same.

2. Related Background Art

FIG. 7 is a flowchart explaining the contents of a related disk analysis process in a data reproducing device such as a CD-MP3 for reproducing data. As shown in FIG. 7, in the related disk analysis process, the data reproducing device first performs a disk analysis of analyzing a file and directory structure of a set disk (step S2).

The data reproducing device then judges whether or not all files in the set disk are detected (step 4). Thereafter, it stores information on the detected files (media files) in a file table.

When all the files are not detected (step S4: No), the disk analysis process is continued (step S2). On the other hand, when all the files are detected (step S4: Yes), the disk analysis is completed, and reproduction of the files is started (step S6).

In the related data reproducing device shown in FIG. 7, one of the greatest number of improvement requests from end users is a request for a reduction in the analysis time from the recognition of a disk to the start of reproduction. This is because in a common audio CD, reproduction is started in a few seconds after a disk is recognized, whereas in the data reproducing device such as the CD-MP3, an analysis is performed using a limited memory, and hence a few tens of seconds (a few minutes depending on disk structure) are needed after a disk is recognized.

This becomes more pronounced when the numbers of directories and files stored in one CD are large since the disk structure becomes more complicated.

### SUMMARY OF THE INVENTION

In order to accomplish the aforementioned and other objects, according to one aspect of the present invention, a data reproducing device, comprises:

a disk analysis executor which performs a disk analysis of analyzing a file and directory structure of a record medium;

a detection judgment section which judges whether or not a predetermined number of files and/or a predetermined number of directories including a file is detected by the disk analysis executor; and

a reproduction starter which suspends the disk analysis and starts reproduction of data of the detected file when the detection judgment section judges that the predetermined number of files and/or the predetermined number of directories including the file is detected.

According to another aspect of the present invention, a control method of a data reproducing device, comprises:

performing a disk analysis of analyzing a file and directory structure of a record medium;

judging whether or not a predetermined number of files and/or a predetermined number of directories including a file is detected; and

suspending the disk analysis and starting reproduction of data of the detected file when it is judged that the predetermined number of files and/or the predetermined number of directories including the file is detected.

### BRIEF DESCRIPTION OF THE DRAWINGS

FIG. 1 is a block diagram showing an example of the configuration of a data reproducing device according to a first embodiment;

FIG. 2 is a diagram showing an example of the structure of directories and files stored in a CD;

FIG. 3 is a diagram showing an example of the structure of a file table according to the first embodiment;

FIG. 4 is a diagram showing an example of the configuration of a data buffer according to the first embodiment;

FIG. 5 is a flowchart explaining the contents of a disk analysis process according to the first embodiment;

FIG. 6 is a flowchart explaining the contents of a disk analysis process according to a second embodiment; and

FIG. 7 is a flowchart explaining the contents of a related disk analysis process.

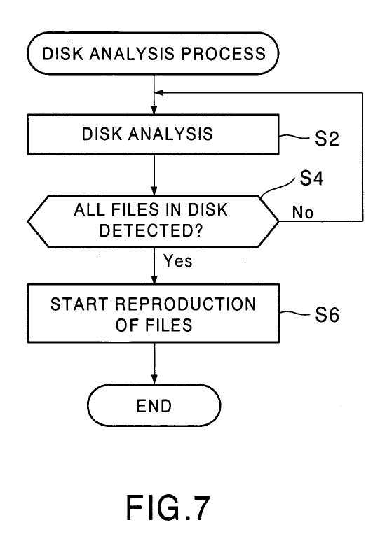

### DETAILED DESCRIPTION OF THE EMBODIMENTS

### First Embodiment

As described above, in a related data reproducing device, file reproduction is started after a disk analysis of a set disk is all completed, but in this embodiment, at a point in time when any number of files (the number is an arbitrary number equal to or more than one) are detected during a disk analysis, the disk analysis is temporarily suspended and reproduction of the file or files is started, whereby the time between the setting of the disk and the start of reproduction is reduced.

File reproduction is performed while reading to and from a buffer memory is being performed, whereby an idle time during which access to the disk is unnecessary occurs. The disk analysis is continued using this idle time, which makes it possible to perform the disk analysis while performing the reproduction, so that the suspended disk analysis can be performed to the last. At this time, by determining the number of files at any number when files to be reproduced are designated, the reproduction can be prevented from being stopped during the analysis. A more detailed explanation will be given below.

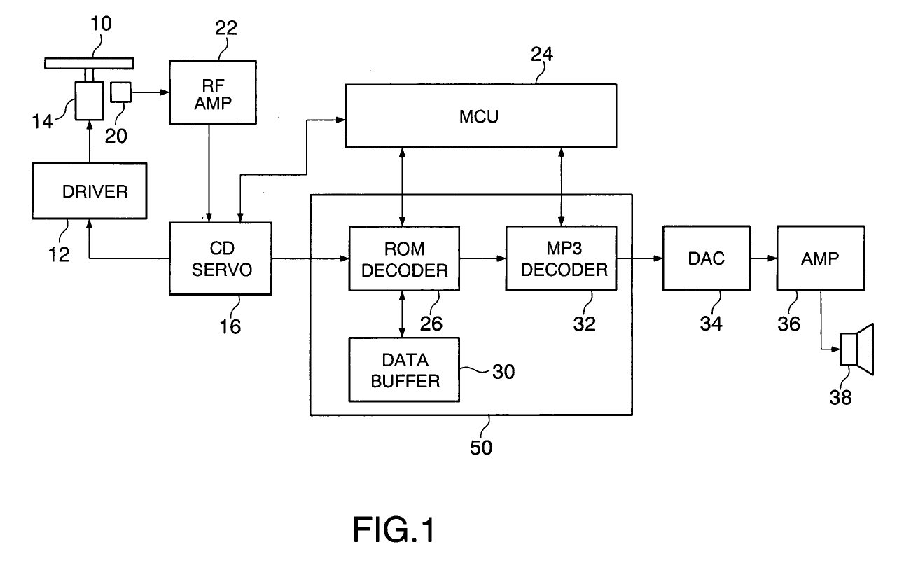

FIG. 1 is a block diagram explaining the configuration of a compressed data reproducing device according to this embodiment. In FIG. 1, data compressed according to MP3 is stored in a CD (compact disc) 10, the MP3 is one of MPEG audio CD data compression standards. This CD 10 is rotated by a motor 14 which is driven by a driver 12. The driver 12 is controlled by a CD servo 16 and rotates the CD 10 at a constant angular speed.

A reproduction signal obtained corresponding to a pit row on a track with the rotation of the CD10 is supplied from a pickup 20 to an RF amplifier 22, amplified, and supplied to the CD servo 16. The CD servo 16 is controlled by a microcomputer (MCU) 24, and a bit stream converted to a digital signal is generated in the CD servo 16.

The bit stream generated in the CD servo 16 is supplied to a ROM decoder 26. The ROM decoder 26 decodes this bit stream and acquires MP3 data compressed by the MP3. This MP3 data is stored in a data buffer 30, read from the data buffer 30 in sequence, and supplied to an MP3 decoder 32. The MP3 decoder 32 decodes this MP3 data to generate PCM audio data and outputs the PCM audio data to a digital-analog converter 34. Both the ROM decoder 26 and the MP3 decoder are also controlled by the microcomputer 24. Moreover, in this embodiment, the ROM decoder 26, the data buffer 30, and the MP3 decoder 32 are formed in one semiconductor chip 50. Further, the ROM decoder 26 according to this embodiment contains a controller, which controls various processes in disk analysis.

The digital-analog converter 34 to which the PCM audio data is inputted converts the PCM audio data to an analog signal and outputs the analog signal to an amplifier 36. The analog signal amplified by the amplifier 36 is reproduced by a speaker 38 to obtain a reproduced sound.

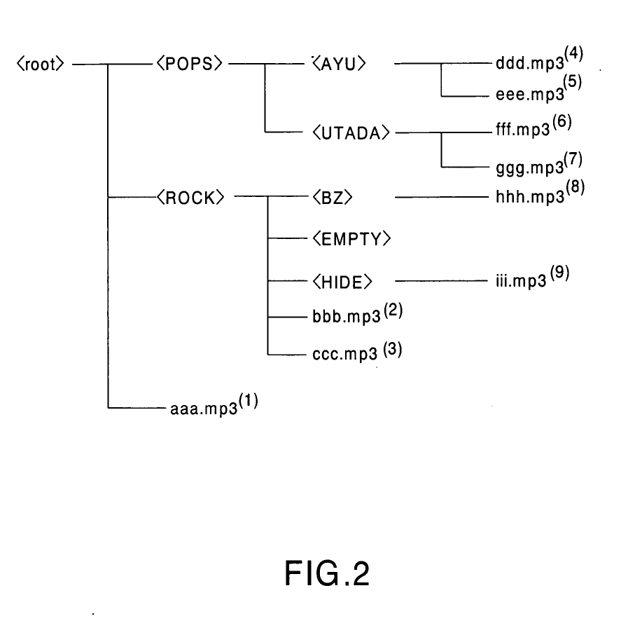

FIG. 2 is a diagram showing an example of the disk structure of the CD 10 in this embodiment. In the example in FIG. 2, a <root> directory is located in a highest level, and a <POPS> directory, a <ROCK> directory, and a file aaa.mp3 are located in a second level.

In a third level, an <AYU> directory and an <UTADA> directory are located in a level under the <POPS> directory. In the third level, a <BZ> directory, an <EMPTY> directory, a <HIDE> directory, a file bbb.mp3, and a file ccc.mp3 are located in a level under the <ROCK> directory.

In a fourth level, a file ddd.mp3 and a file eee.mp3 are located in a level under the <AYU> directory. In the fourth level, a file fff.mp3 and a file ggg.mp3 are located in a level under the <UTADA> directory. In the fourth level, a file hhh.mp3 is located in a level under the <BZ> directory, and a file iii.mp3 is located in a level under the <HIDE> directory.

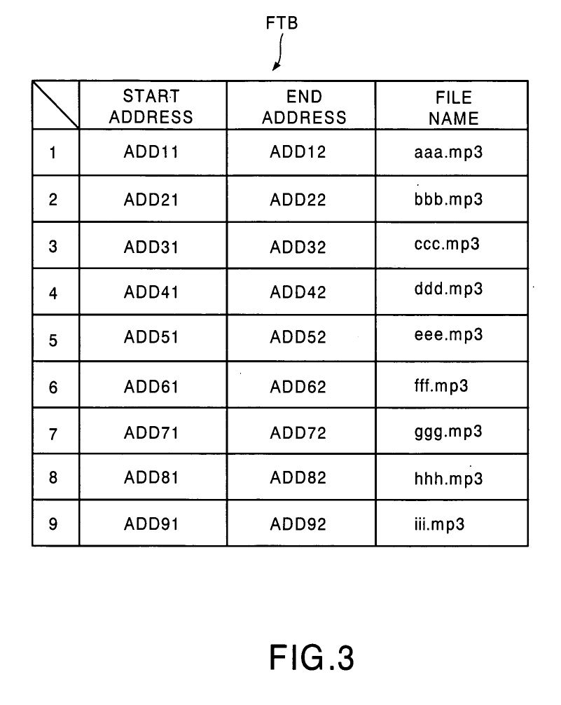

FIG. 3 is a diagram showing an example of a file table FTB generated by performing a disk analysis of the CD 10 having the disk structure shown in FIG. 2. In this case, as shown in FIG. 3, regarding the order of tracks, a file in the higher level is reproduced first, and tracks in the same level are reproduced in alphabetical order. This complies with the ISO 9660.

Moreover, in this embodiment, in the file table FTB, a start address and an end address of the data stored on the CD 10 for each file are stored on a file-by-file basis.

As described above, in a related data reproducing device, after a disk analysis of one CD 10 which is set in the data reproducing device is completed, that is, after generating the file table FTB in FIG. 3 is finished, reproduction of respective files is started in order from the first one. On the other hand, in this embodiment, at a point in time when a predetermined number (for example, two) of files are detected and information thereon is stored in the file table FTB, reproduction is started from the first music. The disk analysis is restarted through the use of the idle time of reproduction to successively create the file table FTB.

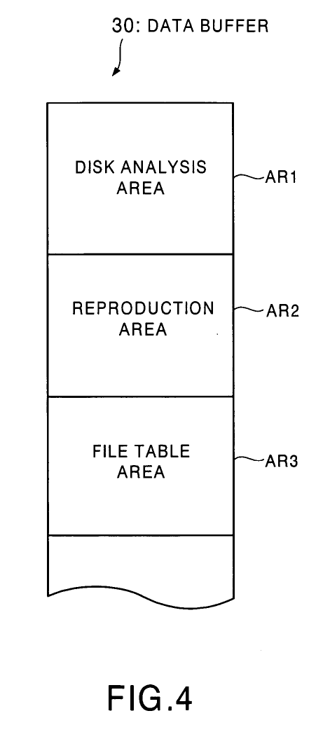

FIG. 4 is a diagram explaining the configuration of a memory area of the data buffer 30 according to this embodiment. In the example in FIG. 4, a disk analysis area AR1, a reproduction area AR2, and a file table area AR3 are formed in the data buffer 30.

The disk analysis area AR1 is an area in which the ROM decoder 26 holds data necessary for the disk analysis of the CD 10. The reproduction area AR2 is an area in which the MP3 data for reproduction is stored. The MP3 data is read in sequence from this reproduction area AR2 and outputted to the MP3 decoder 32. The file table area AR3 is an area in which the file table FTB shown in FIG. 3 is formed and stored.

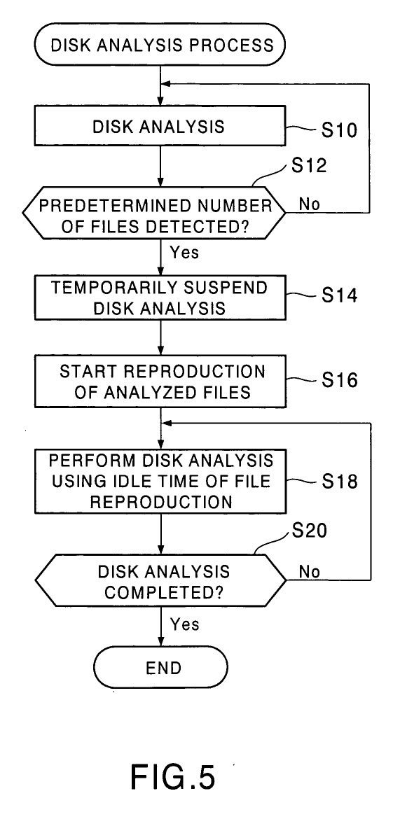

FIG. 5 is a flowchart explaining the contents of a disk analysis process executed by the controller contained in the ROM decoder 26 according to this embodiment. The disk analysis shown in FIG. 5 is a process started when a user sets the new CD 10 in the data reproducing device, or the like.

In this disk analysis process, first, the ROM decoder 26 performs a disk analysis of the CD10 (step S10). More specifically, the ROM decoder 26 reads data necessary for the disk analysis from the CD 10 and stores the data in the disk analysis area AR1 of the data buffer 30. Then, directory structure specification and file detections are performed. Information on the detected file (media file) is stored in the aforementioned file table FTB.

While performing this disk analysis process, the ROM decoder 26 judges whether or not a predetermined number of files are detected (step S12). This predetermined number may be set in design time in advance or may be settable at the discretion of a user. In this embodiment, the predetermined number is set, for example, at two.

When the predetermined number of files are not detected (step S12: No), the disk analysis process is continued (step S10). On the other hand, when the predetermined number of files are detected (step S12: Yes), the disk analysis is temporarily suspended (step S14). In the example in FIG. 2 and FIG. 3 in this embodiment, at this suspended point in time, information on two files of the file aaa.mp3 and the file bbb.mp3 is stored in the file table FTB.

Thereafter, the ROM decoder 26 starts reproduction of analyzed files (step S16). More specifically, the ROM decoder 26 reads data (bit stream) from a start address of the file aaa.mp3 which is the first music and stores it as MP3 data in the reproduction area AR2 of the data buffer 30. Generally, the size of the reproduction area AR2 is smaller than the data size of one track, and hence only data of an amount storable in the reproduction area AR2 is read from the CD 10. Then, the ROM decoder 26 reads the MP3 data in sequence and sends it to the MP3 decoder to reproduce it, and, for example, at a point in time when the amount of not-yet-reproduced MP3 data becomes smaller than 20% of the size of the reproduction area AR2, the ROM decoder 26 starts to read a continuation of the data from the CD 10.

Accordingly, while the MP3 data is read from the reproduction area AR2 and being reproduced, it is unnecessary to access the CD 10. Hence, in this embodiment, a continuation of the disk analysis is performed using this idle time (step S18). If the amount of the not-yet-reproduced data in the reproduction area AR2 lessens while the disk analysis is being performed, the disk analysis is temporarily suspended, and a continuation of the data for reproduction is read from the CD 10.

Then, this process is repeated until the disk analysis of one CD 10 is completed, so that the file table FTB shown in FIG. 3 is finished. At a point in time when the file table FTB concerning one CD 10 is finished, this disk analysis process ends. Consequently, the ROM decoder 26 can be engaged exclusively in the process for file reproduction.

The amount of the not-yet-reproduced data in the reproduction area AR2 at which the disk analysis is suspended and additional data is read may be set in design time in advance or may be settable at the discretion of the user. When the amount of nor-yet-reproduced MP3 data is set at a large amount (for example, when the amount is set at 60% of the reproduction area AR2), the possibility that the reproduced track is interrupted halfway can be reduced. On the other hand, when the amount of nor-yet-reproduced MP3 data is set at a small amount (for example, when the amount is set at 20% of the reproduction area AR2), the disk analysis process can be performed rapidly.

Moreover, when the disk analysis is suspended and additional data for reproduction is read, the ROM decoder 26 designates an address at which the additional data is read to the microcomputer (MCU) 24 to request a readout access of the CD 10.

As described above, according to the data reproducing device of this embodiment, the time between the recognition of the CD 10 and the reproduction thereof can be made almost equal to the time until the predetermined number of files are detected in the disk analysis process. As a result, the reproduction of the first music can be started in about a few seconds after the data reproducing device recognizes the CD 10. This makes it possible to greatly reduce user's waiting time until the reproduction of the first music is started.

Further, in the related data reproducing device, there is a large difference in the time required for disk analysis depending on the directory structure and number of files of a disk (CD 10), but according to this embodiment, the reproduction becomes possible at a point in time when the predetermined number of files are detected, whereby a difference in the time required until the reproduction is started, which is caused by a difference in disk structure, can be almost eliminated.

### Second Embodiment

Generally, disk analysis is performed on a directory-by-directory basis. Therefore, in the second embodiment, at a point in time when a predetermined number of directories including a file or files are detected, the disk analysis is temporarily suspended and file reproduction is started.

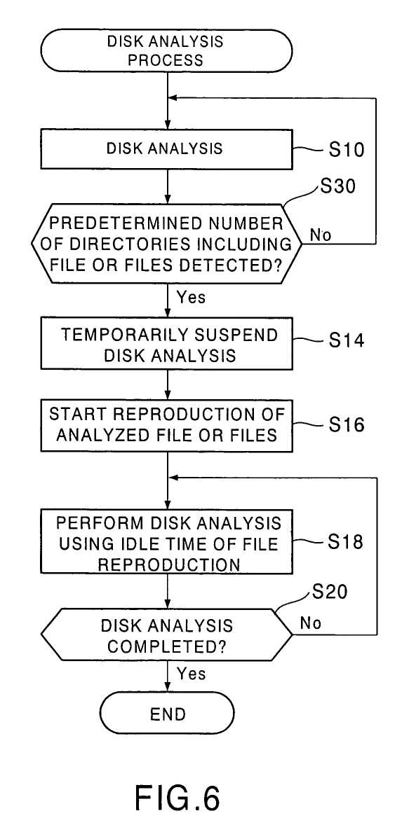

FIG. 6 is a flowchart explaining the contents of a disk analysis process according to this embodiment. As can be seen from FIG. 6, in the disk analysis process according to this embodiment, step S30 is executed in place of step S12 in the aforementioned first embodiment.

Namely, the controller of the ROM decoder 26 performs a disk analysis and judges whether or not a predetermined number of directories including a file or files (media file or files) are detected (step S30). Then, the disk analysis is performed until the predetermined number of directories including a file or files are detected.

When the predetermined number of directories including a file or files are detected (step S30: Yes), the disk analysis is temporarily suspended (step S14), and reproduction of an analyzed file or analyzed files is started (step S16).

In this embodiment, the predetermined number of directories is, for example, one. Hence, the file aaa.mp3 under the <root> directory shown in FIG. 2 is detected, and at a point in time when information on this file is stored in the file table FTB, the disk analysis is suspended, and reproduction of the file aaa.mp3 is started.

As described above, according to the data reproducing device of this embodiment, the time between the recognition of the CD 10 and the reproduction thereof can be made almost equal to the time until a predetermined number of directories including a file or files are detected in the disk analysis process. As a result, the reproduction of the first music can be started in about a few seconds after the data reproducing device recognizes the CD 10. This makes it possible to greatly reduce user's waiting time until the reproduction of the first music is started.

Further, in the related data reproducing device, there is a large difference in the time required for disk analysis depending on the directory structure and number of files of a disk (CD 10), but according to this embodiment, the reproduction becomes possible at a point in time when the predetermined number of directories are detected, whereby a difference in the time required until the reproduction is started, which is caused by a difference in disk structure, can be almost eliminated.

Furthermore, when the disk analysis is restarted after it is temporarily suspended, as concerns the predetermined number of directories, the disk analysis thereof is completed, whereby the time required for disk analysis can be reduced further than in the first embodiment. This is because in the first embodiment, disk analysis needs to be performed again on a directory or directories from which the predetermined number of files are detected to confirm whether other files exist therein.

It should be mentioned that the present invention is not limited to the aforementioned embodiments, and various changes may be made therein. For example, the data stored in the CD10 is compressed by the MP3 in the aforementioned embodiments, but the data may be compressed in some other format such as WMA (Windows Media Audio). In addition, the data stored in the CD 10 is not necessarily compressed data.

Moreover, the aforementioned embodiments are explained with a case where the data stored in the CD 10 is audio data as their example, but some other kind of data such as image data may be stored in the CD 10. In this case, it is suitable to use a device corresponding to the kind of the data as the data reproducing device.

Further, the CD 10 is used as an example of a record medium for recoding data in the aforementioned embodiments, but the present invention is applicable to other record media such as a DVD (Digital Versatile Disc).

Furthermore, in the aforementioned embodiments, the reproduction of data on the detected files is started when it is judged that the predetermined number of files are detected (the first embodiment) or when it is judged that the predetermined number of directories including a file or files are detected (the second embodiment), but the reproduction of data may be started when both of these are detected. In other words, by using the first embodiment and the second embodiment in combination, when it is judged the predetermined number of files and the predetermined number of directories including a file or files are detected, the reproduction of data may be started.

Additionally, the data buffer 30 is built in the semiconductor chip 50 in the aforementioned embodiments, but the entire data buffer 30 may be externally mounted. Besides, a part of the data buffer 30 may be externally mounted to the semiconductor chip 50. For example, it is also possible to internally mount the file table area AR3 in the semiconductor chip 50, and externally mount the disk analysis area AR1 and the reproduction area AR2 to the semiconductor chip 50.

1. A data reproducing device, comprising:
a disk analysis executor which performs a disk analysis of analyzing a file and directory structure of a record medium;
a detection judgment section which judges whether or not a predetermined number of files and/or a predetermined number of directories including a file is detected by the disk analysis executor; and
a reproduction starter which suspends the disk analysis and starts reproduction of data of the detected file when the detection judgment section judges that the predetermined number of files and/or the predetermined number of directories including the file is detected.

2. The data reproducing device according to claim 1, further comprising a disk analysis continuator which, when an idle time during which access to the record medium is unnecessary occurs while the data of the detected file is being reproduced, continues the disk analysis using the idle time.

3. The data reproducing device according to claim 2, further comprising:
a data storage in which data of a file read from the record medium is stored; and
a data reproducer which reads the data from the data storage and reproduces the data.

4. The data reproducing device according to claim 3, further comprising an additional reader-storage which, when an amount of not-yet-reproduced data stored in the data storage is smaller than a predetermined amount, suspends the disk analysis by the disk analysis continuator, reads a continuation of the data from the record medium, and stores the continuation of the data in the data storage.

5. The data reproducing device according to claim 3, wherein the data reproducer comprises a reproduction data generator which decodes the data to generate data for reproduction when the data is reproduced.

6. The data reproducing device according to claim 4, wherein the predetermined amount at which the additional reader-storage starts to read the continuation of the data is settable at any amount.

7. The data reproducing device according to claim 6, wherein the data reproducer comprises a reproduction data generator which decodes the data to generate data for reproduction when the data is reproduced.

8. A control method of a data reproducing device, comprising:
performing a disk analysis of analyzing a file and directory structure of a record medium;
judging whether or not a predetermined number of files and/or a predetermined number of directories including a file is detected; and
suspending the disk analysis and starting reproduction of data of the detected file when it is judged that the predetermined number of files and/or the predetermined number of directories including the file is detected.

9. The control method of a data reproducing device according to claim 8, further comprising, when an idle time during which access to the record medium is unnecessary occurs while the data of the detected file is being reproduced, continuing the disk analysis using the idle time.

10. The control method of a data reproducing device according to claim 9, further comprising:
storing data of a file read from the record medium in a data storage; and
reading the data from the data storage and reproducing the data.

11. The control method of a data reproducing device according to claim 10, further comprising, when an amount of not-yet-reproduced data stored in the data storage is smaller than a predetermined amount, suspending the disk analysis, reading a continuation of the data from the record medium, and storing the continuation of the data in the data storage.

12. The control method of a data reproducing device according to claim 10, further comprising decoding the data to generate data for reproduction when the data is reproduced.

13. The control method of a data reproducing device according to claim 11, wherein the predetermined amount for starting to read the continuation of the data is settable at any amount.

14. The control method of a data reproducing device according to claim 13, further comprising decoding the data to generate data for reproduction when the data is reproduced.

15. A data reproducing device, comprising:
a data reader which reads data from a record medium;
a disk analysis executor which performs a disk analysis of analyzing a file and directory structure of the record medium in accordance with the data read by the data reader;
a detection judgment section which judges whether or not a predetermined number of files and/or a predetermined number of directories including a file is detected by the disk analysis executor;
a reproduction starter which suspends the disk analysis and starts reproduction of the data of the detected file when the detection judgment section judges that the predetermined number of files and/or the predetermined number of directories including the file is detected; and
an output section which outputs the result of the reproduction of the data.
